(19) United States
(12) Patent Application Publication
(10) Pub. No.: US 2024/0320433 A1
(43) Pub. Date: Sep. 26, 2024

(54) SPECULATIVE DECODING IN AUTOREGRESSIVE GENERATIVE ARTIFICIAL INTELLIGENCE MODELS

(71) Applicant: QUALCOMM Incorporated, San Diego, CA (US)

(72) Inventors: Christopher LOTT, San Diego, CA (US); Mingu LEE, San Diego, CA (US); Joseph Binamira SORIAGA, San Diego, CA (US); Jilei HOU, San Diego, CA (US)

(21) Appl. No.: 18/479,672

(22) Filed: Oct. 2, 2023

Related U.S. Application Data
(60) Provisional application No. 63/454,605, filed on Mar. 24, 2023.

(51) Int. Cl. G06F 40/284; G06F 16/22

(52) U.S. Cl. CPC G06F 40/284; G06F 16/2246

(57) ABSTRACT

Certain aspects of the present disclosure provide techniques and apparatus for generating a response to an input query using generative models. The method generally includes generating, based on an input query and a first generative model, a first plurality of sets of tokens. The first plurality of sets of tokens are output to a second generative model for verification. While waiting to receive an indication of a selected set of tokens from the first plurality of sets of tokens, a second plurality of sets of tokens are speculatively generated. The indication of a selected set of tokens from the first plurality of sets of tokens is received. Tokens from the second plurality of sets of tokens associated with the selected set of tokens are output to the second generative model for verification, and the selected set of tokens is output as a response to the input query.

### CROSS-REFERENCE TO RELATED APPLICATIONS

This application claims priority to and benefit of U.S. Provisional Patent Application Ser. No. 63/454,605, entitled “Speculative Decoding in Autoregressive Generative Artificial Intelligence Models,” filed Mar. 24, 2023, and assigned to the assignee hereof, the entire contents of which are incorporated herein by reference.

### INTRODUCTION

Aspects of the present disclosure relate to generative artificial intelligence models, and more specifically to speculative decoding in generative artificial intelligence models.

Generative artificial intelligence models can be used in various environments in order to generate a response to an input query. For example, generative artificial intelligence models can be used in chatbot applications in which large language models (LLMs) are used to generate an answer, or at least a response, to an input query. Other examples in which generative artificial intelligence models can be used include stable diffusion, in which a model generates an image from an input text description of the content of the desired image, and decision transformers, in which future actions are predicted based on sequences of prior actions within a given environment.

Generally, generating a response to a query using generative artificial intelligence models may be computationally expensive. For example, in a chatbot deployment in which a large language model is used to generate a response to a query formatted as a text query, a response to the query may be generated using a pass through the large language model for each token (e.g., word or part of word) generated as part of the response. The output of each pass may be a probability distribution on a set of tokens (e.g., words or parts of words) from which the next token (e.g., word or part of word) may be selected, either by sampling or based on maximum likelihood, for example. Because a pass through a large language model is used to generate each word (or token(s)) in a response to a query, the computational expense may be modeled as the product of the number of words included in the response and the computational resource expense (e.g., in terms of processing power, memory bandwidth, and/or other compute resources used) of performing a pass through the large language model, which generally increases as the number of parameters within the large language model increases.

### BRIEF SUMMARY

Certain aspects of the present disclosure provide a method for generating a response to an input query using a generative artificial intelligence model. The method generally includes generating, based on an input query and a first generative model, a plurality of sets of tokens, each set of tokens in the plurality of sets of tokens corresponding to a candidate response to the input query. The plurality of sets of tokens are output to a second generative model for verification. An indication of a selected set of tokens from the plurality of sets of tokens is received from the second generative model based on the input query and the plurality of sets of tokens. The selected set of tokens is output as a response to the input query.

Certain aspects of the present disclosure provide a method for verifying a response to an input query generated using a generative artificial intelligence model. The method generally includes receiving an input query and a plurality of sets of tokens generated by a first generative model, each set of tokens in the plurality of sets of tokens corresponding to a candidate response to the input query. A probability distribution associated with each respective set of tokens in the plurality of sets of tokens is compared to a corresponding probability distribution generated by a second generative model for the respective set of tokens. A set of tokens is selected based on the comparing, and the selected set of tokens is output to the first generative model.

Certain aspects of the present disclosure provide a method for parallel speculative generation of a response to an input query using generative artificial intelligence models. The method generally includes generating, based on an input query and a first generative model, a first plurality of sets of tokens, each set of tokens in the first plurality of sets of tokens corresponding to a first portion of a candidate response to the input query. The first plurality of sets of tokens are output to a second generative model for verification. While waiting to receive, from the second generative model, an indication of a selected set of tokens from the first plurality of sets of tokens, a second plurality of sets of tokens are speculatively generated, each set of tokens in the second plurality of sets of tokens corresponding to a second portion of the candidate response to the input query. The indication of a selected set of tokens from the first plurality of sets of tokens is received from the second generative model. Tokens from the second plurality of sets of tokens associated with the selected set of tokens are output to the second generative model for verification, and the selected set of tokens is output as a response to the input query.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict only certain aspects of this disclosure and are therefore not to be considered limiting of the scope of this disclosure.

FIG. 1 illustrates an example of group speculative decoding in generative models, according to aspects of the present disclosure.

FIG. 2 illustrates an example relationship between a draft model and a target model used in group speculative decoding in generative models, according to aspects of the present disclosure.

FIG. 3 illustrates an example of parallel speculative decoding in generative models, according to aspects of the present disclosure.

FIG. 4 illustrates an example pipeline for hybrid speculative decoding in generative models, according to aspects of the present disclosure.

FIG. 5 illustrates an example of hybrid speculative decoding in generative models, according to aspects of the present disclosure.

FIG. 6 illustrates an example of hybrid parallel speculative decoding in generative models, according to aspects of the present disclosure.

FIG. 7 illustrates an example of hybrid group speculative decoding in generative models, according to aspects of the present disclosure.

FIG. 8 illustrates example operations for generating a response to an input query using generative artificial intelligence models, according to aspects of the present disclosure.

FIG. 9 illustrates example operations for verifying a response to an input query using generative artificial intelligence models, according to aspects of the present disclosure.

FIG. 10 illustrates example operations for speculatively generating a response to an input query and verifying the response to the input query using generative artificial intelligence models, according to aspects of the present disclosure.

FIG. 11 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatus, methods, processing systems, and computer-readable mediums for efficiently generating responses to input queries using generative artificial intelligence models.

Generally, generative artificial intelligence models generate a response to a query input into the model. For example, a large language model (LLM) deployed within a chatbot can generate a response to a query using multiple passes through the large language model, with each successive pass being based on the query and the tokens (or words or parts thereof) generated using previous passes through the large language model. Generally, these large language models may include millions, or even billions, of weights or parameters within the model. Because of the size of these models and the operations performed on each token to predict what should be the next token generated in response to a query and the previously generated tokens, it may not be practical, or even possible, to deploy large language models on a variety of devices which may have limited memory, storage, and/or processing capabilities relative to cloud compute instances on which large language models typically operate. Further, the computational complexity involved in generating a response to a query provided as input into a model may involve significant energy expenditure, processing time, memory utilization, and/or other resource utilization which may prevent compute resources from being used for other tasks.

To improve the efficiency and throughput of large language models, speculative decoding techniques allow for a smaller language model, sometimes known as a draft large language model (also referred to as a draft model), to execute with a larger language model, sometimes known as a target large language model (also referred to as a target model). In such a case, the draft model can generate speculatively additional tokens and probabilities used for sampling these additional tokens based on a current set of accepted tokens. The target model can generate tokens based on the tokens generated by the draft model. To generate a result, the target model can perform rejection sampling on a per-token basis to accept or reject tokens generated by the draft model such that the draft model and the target model have similar probability distributions.

In some aspects, the draft model may be a pruned version of the target model chosen such that the draft model and target model have similar probability distributions. In other aspects, the draft model may be a smaller version of the target model (e.g., trained on millions of tokens, instead of hundreds of millions or even billions of tokens).

Aspects of the present disclosure provide techniques for generating responses to a query input into a large language model on a group basis using speculative decoding techniques. Generally, the draft model can generate one or more sets of tokens as candidate responses to the query. The target model, in turn, can perform sampling rejection on a per-set basis. Tokens within a group can be selected based on conditional probabilities of tokens within the group. By performing rejection sampling on a per-set basis, aspects of the present disclosure may retain a close relationship between the probability distributions within the draft and target models, while increasing the throughput of the draft and target models (e.g., the number of tokens generated per second) relative to draft and target models configured to generate responses on a per-token basis.

Aspects of the present disclosure provide techniques for generating responses to a query input into a large language model using speculative decoding techniques in which a draft model and a target model operate in parallel, also referred to herein as “hybrid speculative decoding.” In hybrid speculative decoding techniques, a draft model can speculatively generate one or more tokens while previously speculatively generated tokens are verified by the target model. The draft model may execute on an edge device, and the target model may execute on a server (e.g., locally accessible by the edge device, hosted in a cloud computing environment, etc.). By executing both the draft model and the target model in parallel, the rate at which tokens are generated may be maximized, or at least increased. Further, in situations in which the edge device is disconnected from the server, the edge device can continue to generate tokens in order to generate a response to a received query.

### Speculative Decoding in Generative Artificial Intelligence Models

Generally, autoregressive token generation (e.g., in large language models) may take historical tokens as an input in order to generate an output. That is, autoregressive token generation may be represented by the expression:

$${x}_{t} ∼ p ( x \vert {x}_{0} , {x}_{1} , … , {x}_{t - 1} ) \to {x}_{t + 1} ∼ p ( x \vert {x}_{0} , {x}_{1} , … , {x}_{t - 1} , {x}_{t} )$$

where xₜ represents a sequence of tokens generated at time t, having a conditional probability p conditioned on the selection of tokens x₀ through xₜ₋₁, and xₜ₊₁ represents a sequence of tokens generated at time t+1, having a conditional probability p conditioned on the selection of tokens x₀ through xₜ. Generally, a single token may be generated each time an autoregressive model is executed, which means that N inferences may be performed to generate a sequence of N tokens. As discussed above, speculative decoding techniques can be used to accelerate token generation by using a draft model, smaller in size than the target model, that speculatively generates tokens, with the target model being used to verify the tokens (speculatively) generated by the draft model.

In a speculative decoding pipeline, the draft model may speculatively generate n tokens autoregressively, according to the expression:

$${x}_{t + 1}^{draft} ∼ {p}_{t}^{draft} = {p}^{draft} ( x \vert {x}_{0} , … {x}_{t} ) {x}_{t + 2}^{draft} ∼ {p}_{t + 1}^{draft} , … , {x}_{t + n}^{draft} ∼ {p}_{t + n - 1}^{draft}$$

where t corresponds to a point in time and pₜ^{draft} corresponds to the conditional probability distribution associated with a selected token x at time t conditioned on the selection of tokens x₀ through xₜ₋₁.

The target model takes the generated n tokens and processes the n tokens in parallel to generate probability distributions for each of the n tokens, according to the expression:

$$[ {p}_{t}^{target} , {p}_{t + 1}^{target} , … , {p}_{t + n}^{target} ] = {[ {p}^{target} ( x \vert {x}_{0} , … {x}_{t} , {x}_{t + 1}^{draft} , … , {x}_{t + k}^{draft} ) ]}_{k = 1 , 2 , … , n}$$

where k corresponds to a token index relative to the generated n tokens.

The target model can then verify the tokens generated by the draft model by comparing distributions from the draft model and target model to determine whether a token is accepted or rejected. A given token xₜ₊ₖ^{draft} may be accepted when ƒ(pₓ^{draft},pₖ^{target})<α, for some function ƒ and some threshold α (also known as an acceptance rate). Otherwise, the token may be rejected. The final token may then be generated at the first rejection position or at the last position n based on some function g(pₖ^{draft},pₖ^{target}).

Speculative decoding, with an acceptance rate of α, may result in cost reductions relative to using a single autoregressive model to generate tokens iteratively. Inference cost savings, relative to iterative token generation, may be represented by the expression:

$${C}^{A R} = {NC}^{target} \to {C}^{SD} = {nNC}^{draft} + \frac{N}{α + 1} {C}^{target}$$

Consider the example, for N=1000, C^{target}=10, C^{draft}=1, n=4, α=3, wherein N corresponds to a number of tokens, C^{AR} corresponds to a computational cost using an acceptance rate of α, C^{target} corresponds to a computational cost of generating a set of tokens using the target model, C^{draft} corresponds to a computational cost of generating a set of tokens using the draft model, and n corresponds to a number of tokens generated speculatively generated tokens generated through a single pass through an autoregressive model. In such an example, speculative decoding may result in a 35% reduction in computational expense relative to autoregressive iterative token generation alone.

However, speculative decoding on a per-token basis, as discussed, may impose limits on the rate at which tokens are generated, as a first token may be sampled individually by a draft model and then verified by a target model before the next token is sampled by the draft model and verified by the target model. That is, generating response to an input query using per-token speculative decoding techniques may involve executing the draft model and target model for each token generated as part of a response to the input query, which may use significant amounts of computational resources (e.g., processor time, memory, memory bandwidth, etc.) in order to generate the response.

### Example Group Speculative Decoding in Generative Artificial Intelligence Models

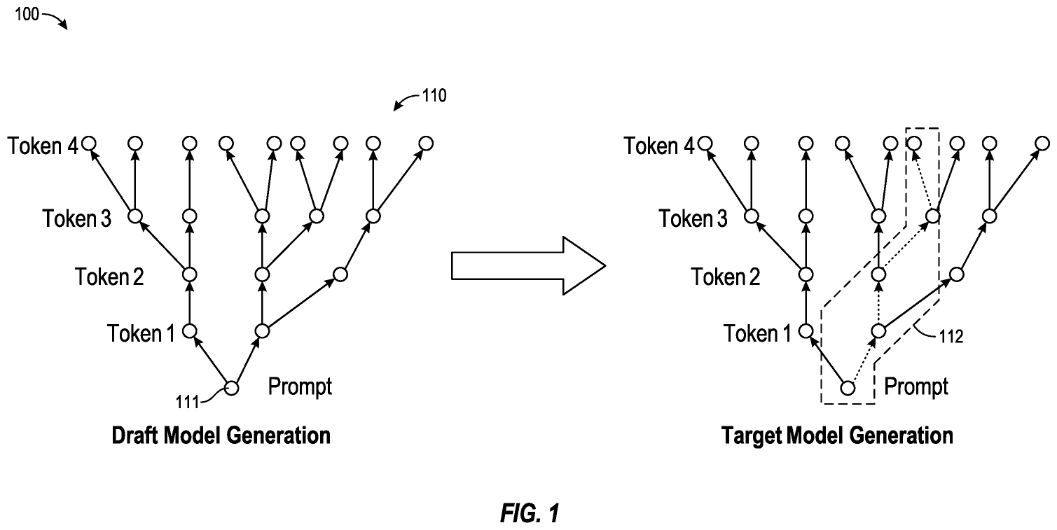

FIG. 1 illustrates an example 100 of group speculative decoding (GSD) in generative artificial intelligence models, according to aspects of the present disclosure.

As illustrated, a draft model and a target model can be used in conjunction (or otherwise together) with each other to perform group speculative decoding of tokens to generate a response to a query received for processing by one or more generative artificial intelligence models. As discussed in further detail below, group speculative decoding of tokens may allow for multiple sets of tokens to be speculatively generated by a draft model for verification by a target model. Because multiple sets of tokens may be generated by a draft model for verification by a target model, group speculative decoding may increase the token generation rate of generative artificial intelligence models by generating multiple sets of tokens that can be accepted as a correct response, as larger numbers of sets of tokens may increase the probability that at least one set includes one or more tokens that will be accepted as a response.

The draft model generally forms a sampled group of tokens including one or more groups of high probability nodes from a probability distribution for an output over a set of potential tokens, given an input of the received query. The groups of high probability nodes may include groups selected based on various techniques, such as top-k selection (e.g., selection of the k tokens having the highest probabilities within a probability distribution), nucleus-based selection (e.g., selection based on a sum of probabilities meeting a threshold probability), or the like. Tokens not included in the one or more groups may be considered singleton set groups (e.g., groups including a single member). By choosing groups of candidate tokens, the draft model can sample tokens based on the probability distribution; however, each group may be treated as a single selection with an aggregate group probability (e.g., as a sum of individual token probabilities) so that the draft model matches, or at least approaches, the target model for the calculated probability of each group being a sufficient response to the received query. Grouping may achieve this match, or at least approximation, between probabilities calculated by the draft and target models because while individual token probabilities may not match well, aggregates of likely tokens may have probabilities that are likely to be similar in the draft and the target models.

When a sampled group of tokens is input into the draft model in the next iteration of executing the draft model, the tokens in the sampled group of tokens are input at the sample location and treated independently. The result may be a tree data structure 110, with a prompt as a root node 111 of the tree data structure, and subsequent levels within the tree data structure 110 representing different tokens (or groups of tokens), combined with each of the previously selected token combinations. At some point in time (e.g., after generating a tree with a defined depth, corresponding to a maximum length of a sequence generated by the draft model), the draft model may output the generated tree data structure 110 to the target model for further processing. The tree data structure 110 may, in some aspects, be output to the target model with groupings and selection probabilities generated by the draft model.

In some aspects, the number of nodes at each level of the tree data structure 110 and the depth of the tree data structure 110 may be defined a priori. The number of nodes at each level of the tree may be defined globally, on a per-level basis, or in some other manner. For instance, the number of nodes at any level of the tree data structure 110 may be defined based on a branching factor at the immediate prior level of the tree data structure 110. For example, a branching factor of 2 for nodes at the n^{th} level of the tree data structure 110 may result in the generation of 2 nodes (tokens) at the n+1^{th} level of the tree data structure 110 for each node (token) at the n^{th} level of the tree. Meanwhile, the depth of the tree data structure 110 may be defined based on a maximum number of tokens (e.g., words) that can be generated using any pass through the draft model. For example, if the draft model is configured to generate a sequence with a maximum length of 5 tokens during any instance of speculative generation, then the depth of the tree may be 6 (to include, at the first level of the tree data structure 110, the root node corresponding to the input into the draft model).

The draft model may be configured to trigger the generation of tokens by the target model based on various complexity and/or performance criteria. For example, the draft model may trigger the generation of tokens by the target model based on a complexity or performance criterion associated with the size of the generated tree. In other examples, the draft model may be configured to trigger the generation of tokens by the target model based on a time criterion associated with an expected amount of time for the target model to generate a set of tokens against which the generated tree can be compared. Generally, these complexity and/or performance criteria may set an upper bound on the number of tokens generated by the draft model for verification by the target model. This upper bound may, in some aspects, be based on a number of nodes in the tree data structure and may be influenced, for example, by a branching factor defined for different levels of a tree data structure into which sampled tokens are organized, a depth of the tree data structure, or the like. The worst-case computational load at the last round of speculative token generation may be configured to be bound by memory bandwidth at the device on which the draft model executes.

Based on the generated tree data structure 110, groupings, and selection probabilities received from the draft model, the target model generates an output (probability) distribution for each partial path of the generated tree data structure 110. Each partial path generally starts from the root node of the generated tree data structure 110 and may be a contiguous path through the generated tree data structure 110 starting from the root node and terminating at any node in the generated tree data structure 110. The target model can generate the output distribution for each partial path, using a single pass through the target model, by, for example, including all tree nodes in the generated tree data structure 110 as token inputs and performing masked self-attention and positional encodings for each partial path within the tree data structure 110. Based on the output distribution for each node in the generated tree data structure 110, the target model can select a set of tokens 112 by traversing from the root node of the generated tree data structure 110. If the target model includes multiple tokens in the selected set of tokens 112, a token can be selected from within the group using the normalized group token probabilities (e.g., token probabilities conditioned on selection of the group including a token), and the selected token may be redefined as the root node of the generated tree data structure 110. The process discussed herein may be repeated, with the selected token defined as the root node of the tree data structure 110, to generate subsequent tokens to include in the selected set of tokens 112.

If a group of tokens is rejected based on the probability distribution generated by the target model, a final group of tokens may be selected based on a group-level rejection sampling method. A final token may be selected from the selected final group of tokens based on normalized group token probabilities. If all groups of tokens are accepted by the target model, a final token may be sampled from a final tree leaf distribution (e.g., a probability distribution generated over the leaf nodes in the tree data structure 110 corresponding to a last accepted or verified token for any partial path through the tree data structure 110), which may allow for the target model to generate an additional token relative to the token(s) speculatively generated by the draft model. The selected set of tokens 112 may then be communicated back to the draft model to be used as an input for a subsequent round of token speculation and verification by the target model, using the techniques discussed herein.

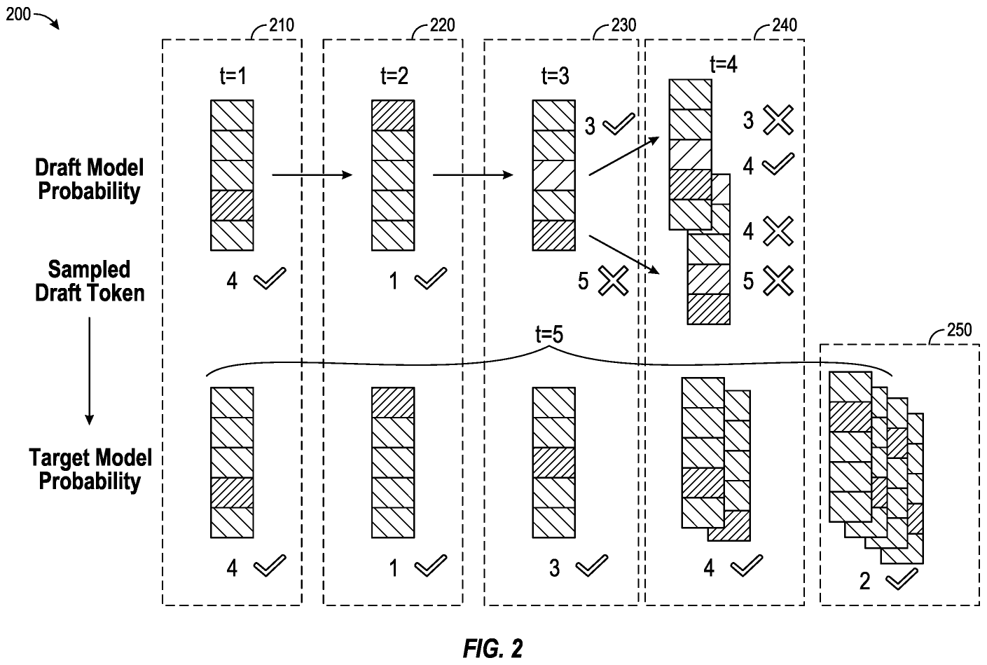

FIG. 2 illustrates an example 200 of a relationship between tokens generated by a draft model and a target model used in group speculative decoding in generative models, according to aspects of the present disclosure.

The tree generated by the draft model generally allows for diverse speculation in which many candidate sets of tokens are provided by the draft model for verification by the target model, which may improve the acceptance rate by the target model of tokens generated by the target model. As illustrated, acceptance of token number 4 of the group of tokens generated by the draft model at time 1=1 210 leads to acceptance of token number 1 of the group of tokens generated by the draft model at time 1=2 220. Subsequently, at time 1=3 230, two options may be present: token number 3 or token number 5. Token number 3 may be accepted as the sampled token, while token number 5 may be rejected as the sampled token, as illustrated. At time 1=4 240, token 4 from the set of tokens speculatively generated based on the selection of token 3 at time t=3 230 may be accepted as the sampled token, based on the calculated probability for tokens 3 and 4 conditioned on acceptance of token 3 at time 1=3 230. Meanwhile, both tokens 4 and 5 from the set of tokens speculatively generated based on the selection of token 5 at time 1=3 230 may be rejected, based on the rejection of token 5 at time t=3 230.

The target model may be fed a token tree as an input instead of a sequence of tokens. For example, the target model may be fed a tree including the options illustrated of token 3 or 5 being a candidate token at time 1=3 230, the options of token 3 or 4 at time 1=4 240 if token 3 is selected at time 1=3 230, and the options of token 4 or 5 at time t=4 240 if token 5 is selected at time t=3 230. As illustrated, at time t=5 250, inputting a token tree data structure (e.g., as illustrated by the sequence of tokens illustrated at times t=1 through t=4) into the target model may allow for the target model to generate an output including five tokens—one more than the sequence(s) of four tokens included in the tree generated by the draft model-which may provide for increased acceptance rates for the token tree and allow for the generation of an additional token to be included in the response generated by the draft and target models. In the example illustrated in FIG. 2, the selected set of five tokens includes token 4 at time t=1 210, token 1 at time t=2 220, token 3 at time t=3 230, token 4 at time t=4 240 (conditioned on the selection of token 3 at time t=3 230), and token 2 at time t=5 250 (conditioned on the selection of token 4 at time t=4 240).

Generally, a new selection of a group of tokens may be performed each time the draft model produces a new distribution for one or more subsequent tokens to be included in a response to a received query processed by the draft model and the target model. As discussed, the use of group selection of tokens may allow for a closer match between draft model probability distributions and target model probability distributions to minimize, or at least reduce, the likelihood of group rejection. In some aspects, the draft model may choose to form no groups when there is a low level of uncertainty (e.g., when the next token selection has low entropy) to minimize, or at least reduce, computational resource expenditure.

Generally, by forming groups of tokens when the use of group speculative decoding (to generate responses to input queries using generative artificial intelligence models) is likely to have a high level of efficacy may reduce compute complexity for both the draft and target models while maintaining a high level of throughput (e.g., the number of tokens generated by the draft and target models per second). Generally, triggering the target model may be impacted by various considerations, such as a maximum tree size to keep model compute performance metrics within a bound, estimates of when longer speculation has diminishing returns (e.g., where the computational expense of generating a larger tree of speculated tokens is unlikely to be valuable, given the likelihood that the target model will reach later tokens in the tree), and other performance considerations.

In some aspects, the draft model may match the target model (e.g., in terms of a probability distribution), but may have faster inference performance than the target model on the same hardware. Generally, smaller models can generate many speculative tokens, but may have an increased likelihood of generated tokens being rejected by the target model. Group speculative decoding, as discussed above, may address this increased likelihood of token rejection, at the expense of increasing computational expense for longer sequences.

In some aspects, at the draft model, a temperature parameter—or a parameter influencing the likelihood of the draft model selecting a token with a lower probability of being an accurate token for inclusion in a set of tokens—may be tuned or otherwise selected to improve the performance of group speculative decoding.

In some aspects, the draft model may be fine-tuned to match (or at least approximate) the target model and maximize (or at least increase) the probability that speculatively generated tokens generated by the draft model will be accepted as valid tokens by the target model.

Generally, token generation performance for group speculative decoding may be increased relative to speculative decoding on a per-token basis. That is, for a given Kullback-Leibler (KL) divergence between the draft model and target model, measuring how the probability distribution of the draft model differs from the probability distribution of the target model (treating the target model as the reference distribution), the number of tokens generated for each target model run may be larger for group speculative decoding than for per-token speculative decoding. Different grouping strategies (e.g., group size, additional tokens, etc.) may have different computational complexity characteristics; thus, the selection of a group strategy may be based on a tradeoff between computational complexity and performance, given bounding parameters of read bandwidth for the draft and target models and hardware performance.

### Example Parallel Speculative Decoding in Generative Artificial Intelligence Models

Group speculative decoding, as discussed above, may allow for the combination of draft model speculative token generation and target model token acceptance to generate a final set of tokens that matches a distribution by the target model while increasing the rate at which tokens are generated. Moreover, aspects of the present disclosure provide for parallel speculative decoding, in which the draft model speculatively generates multiple sets of tokens in parallel, which may provide for increased token generation rates while improving the computational efficiency involved in generating responses to queries using generative artificial intelligence models.

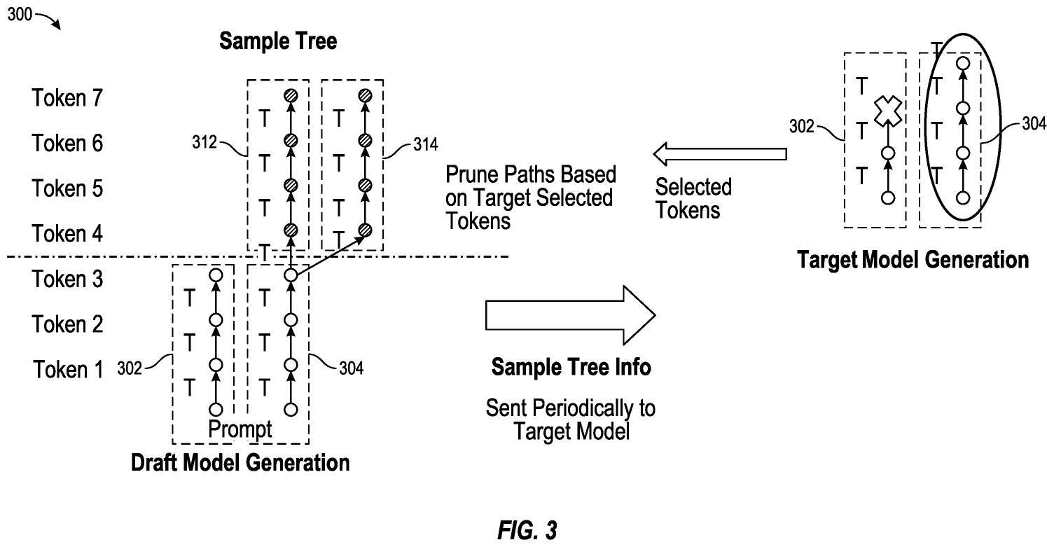

FIG. 3 illustrates an example 300 of parallel speculative decoding (PSD) in generative artificial intelligence models, according to aspects of the present disclosure.

As illustrated, the draft model may run multiple instances of a speculative decoding process to generate a plurality of candidate token sequences. Each iteration may be executed with different parameters, or seeds, for token sampling. Execution of N iterations with S tokens generated per iteration may result in the generation of N*S tokens in total, which may be provided to the target model for processing.

For example, as illustrated in the example 300, the draft model can initially execute multiple instances of a speculative decoding process to generate a first candidate sequence 302 and a second candidate sequence 304 for a prompt input into the draft model. As illustrated, N=2 and S=4; thus, the draft model can generate two sequences with four tokens in each sequence for a total of 8 tokens. It should be recognized that this is but an example, and any values of N and S may be used to define the number of candidate sequences generated by a draft model and the number of tokens included in each sequence, respectively.

The target model uses the N*S tokens as input and processes the N candidate token sequences in one run through the target model. The result of processing the N*S tokens by the target model may be a set of N potentially accepted sequences of varying lengths, depending on where the target model rejected a token in each of the N candidate token sequences. Various techniques can be used to select the final sequence based on the N potentially accepted sequences. As a non-limiting example, a “greedy” technique may result in the selection of the sequence with the longest length, with ties (e.g., between sequences having a same length) broken arbitrarily, which may result in the highest number of tokens being selected each time the target model is run. In some cases, longest-length selection may bias the effective final sampling distribution, which may cause the probability distribution for the target model to converge, at least to some degree, with the probability distribution for the draft model.

For example, as illustrated, the target model accepts two of the four tokens in the first candidate sequence 302 and accepts four of the four tokens in the second candidate sequence 304. Because more tokens are accepted from the second candidate sequence 304 than from the first candidate sequence 302, the “greedy” technique may result in the target model selecting the second candidate sequence 304 as the sequence based on which the draft model generates subsequent candidate sequences 312 and 314. No speculative token generation need be performed based on the first candidate sequence 302 in this case, as the first candidate sequence 302 had fewer accepted tokens than the second candidate sequence 304. However, in other cases, other techniques may be implemented to select one of the candidate sequences, including a sequence that may not have the most accepted tokens.

While FIG. 3 illustrates parallel speculative decoding based on per-token speculative decoding, it should be recognized that the N candidate token sequences can also or alternatively be generated based on the group speculative decoding techniques discussed above. For example, using the group speculative decoding techniques discussed above, multiple sets of tokens, generated by multiple instances of a draft model, may be generated for verification by the target model. In some aspects, sets of tokens generated by an instance of a draft model may be organized into a tree data structure (as discussed above), resulting in the generation of multiple tree data structures, with each individual tree data structure corresponding to sets of tokens generated by a specific instance of a draft model executing using instance-specific parameters. The target model can attempt to verify tokens in each set of tokens to determine the selected set of tokens based on which subsequent speculative decoding is to be performed. The longest path through each tree data structure may be identified as a candidate sequence by the target model. Using a “greedy” technique, the tokens in the candidate sequence with the longest path may be selected as the set of tokens based on which subsequent speculative decoding is to be performed and may be output by the target model to the draft model for the draft model to use as the root node of a subsequent tree data structure (e.g., a tree data structure corresponding to subsequent tokens generated as part of a response to an input query).

### Example Hybrid Speculative Decoding

In some cases, it may be possible to execute generative artificial intelligence models using autoregressive inference in a hybrid system. Examples of these hybrid systems may include systems in which these generative models execute on an edge device (e.g., a smartphone, a tablet computer, a laptop computer, a desktop computer, etc.) and a cloud server, on an edge device and a home server, on different home servers, or the like. Thus, in some aspects, the draft model may execute on a local device, while the target model may execute on a remote device. Executing generative artificial intelligence models in a hybrid system may accelerate the speed at which responses to queries are generated and may reduce the computational load for a server (e.g., by offloading some computational processes to another device). Further, target model accuracy may be preserved when the server on which a target model executes is available, and a large language model (or other generative artificial intelligence model) may remain available (albeit with lower accuracy) at an edge device when the edge device is communicatively disconnected from the server.

In hybrid systems, however, cost reductions may be limited when the draft model and the target model are both hosted in a cloud system. Further, the sequential nature of inferencing (e.g., involving speculatively generating a token using the draft model, then verifying the token using the target model) may limit the rate at which tokens are generated.

To further reduce computational cost involved in generating a response to a query using generative artificial intelligence models, aspects of the present disclosure provide various techniques for speculative decoding in a hybrid environment. In various aspects, speculative decoding in a hybrid environment may be performed such that candidate token set generation using the draft model (e.g., at an edge device) and token verification using the target model (e.g., at a server) can be performed in parallel. The draft model may continue to generate subsequent sets of draft tokens, assuming variations in the accepted number of tokens, where padding may be added to account for differences in the accepted number of tokens from a previous round of speculative token generation. The draft model and target model may execute continuously substantially in parallel, which may accelerate the generation of responses to queries using generative artificial intelligence models.

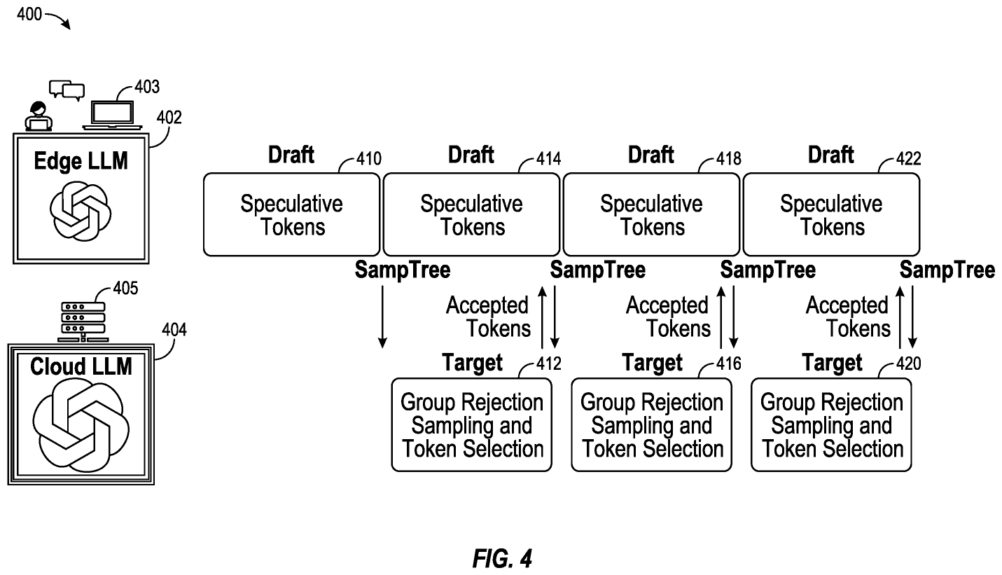

FIG. 4 illustrates an example pipeline 400 for hybrid speculative decoding (HSD) in generative models, according to aspects of the present disclosure.

As illustrated, to maximize, or at least increase, throughput (e.g., the number of tokens generated per second), the draft model 402 executing on an edge device 403 (which may be referred to as a local device or a first device) may continually generate batches of candidate tokens (or sets of tokens, corresponding to different responses of varying lengths to an input prompt, conditioned on any previously accepted tokens) and output these tokens to the target model 404 executing on a server 405 (e.g., in a cloud computing environment) (which may be referred to as a remote device or a second device). The edge device 403 may receive, from the server 405, a set of accepted tokens from the target model 404. The draft model 402 may prune the sample tree to conform to the set of accepted tokens. In some aspects, when the set of accepted tokens is the null set (e.g., when the target model accepts no tokens), the draft model 402 may backtrack to the last token accepted by the target model 404 and restart speculative token generation from the last accepted token. For example, in order to backtrack, the draft model 402 can prune a generated tree of sample tokens to the last accepted token and restart speculative generation based on the pruned tree.

In the example pipeline 400, the draft model 402 executing on the edge device 403 may generate a first set of speculative tokens 410 and output the first set of speculative tokens to the target model 404 executing on the server 405 for verification. In some aspects, the first set of speculative tokens 410 may include multiple subsets of speculative tokens, with each subset corresponding to one or more sequences of tokens generated by different instances of the draft model 402 executing using different operational parameters (e.g., according to group speculative decoding, parallel speculative decoding, or other technique).

In some aspects, while the target model 404 verifies the first set of speculative tokens 410, the draft model 402 can generate a second set of speculative tokens 414. The second set of speculative tokens 414 may be generated based on assumptions that the target model 404 accepted between 1 and S tokens from the first set of speculative tokens 410, where S corresponds to the number of tokens per sequence generated by the draft model 402. The draft model 402 can subsequently receive a selected set of tokens 412 from the target model 404. Based on the selected set of tokens 412, the draft model 402 can identify a subset of the second set of speculative tokens 414 for analysis (e.g., tokens whose generation was conditioned on the acceptance of the correct number of tokens from the first set of speculative tokens 410) and provide this subset to the target model 404 for verification. This process may continue, with the draft model 402 generating a third set of speculative tokens 418 while the target model 404 verifies the second set of speculative tokens 414 and returns a selection 416 from the second set of speculative tokens 414 to the draft model 402, with the draft model 402 generating a fourth set of speculative tokens 422 while the target model 404 verifies the third set of speculative tokens 418 and returns a selection 420 from the third set of speculative tokens 418 to the draft model 402, and so on. In other aspects, the draft model 402 can wait to generate the second set of speculative tokens 414 until the draft model 402 receives the selected set of tokens 412 from the target model 404.

Some of the processes described herein to speculatively generate tokens using a draft model in parallel, or substantially in parallel, with verification of previously generated sets of speculatively generated tokens using a target model may be performed according to group selection and target model triggering conditions selected to achieve continuous, or at least near-continuous, operation of the draft model 402 and the target model 404, while minimizing, or at least reducing, the likelihood that the draft model 402 will backtrack and restart speculative token generation from the last accepted token (e.g., to minimize, or at least reduce, the likelihood that the target model 404 will reject each of the speculatively generated tokens generated by the draft model 402). Further, group selection and target model triggering conditions may be selected so as to avoid, or at least decrease the likelihood of, overburdening compute capabilities on either the edge device or server (e.g., so that the edge device generates tokens and the server verifies tokens within defined performance metrics that minimize, or at least reduce, the likelihood of encountering processing system bottlenecks such as memory thrashing in which data is repeatedly swapped between on-processor and off-processor memory, network bandwidth bottlenecks, and the like).

In some aspects, hybrid speculative decoding may be performed on a per-token basis. In such a case, the draft model 402 may operate continuously and generate various branch paths based on new speculative token generation. In some aspects, the edge device 403 may execute a plurality of original speculative decoding instances (e.g., using different parameters input into the draft model 402), such that the draft model 402 generates multiple paths within a tree representing options which the target model 404 can verify. Based on some defined triggering criteria, the edge device 403 may provide the generated tree to the target model 404 operating on the server 405 (e.g., in a cloud computing environment), which, as discussed above, may select a sequence of tokens corresponding to a likely valid response to an input query and return the selected sequence to the draft model 402 executing on the edge device. The draft model 402 may then prune the generated tree to conform to the selected sequence returned by the target model 404. In this example, the token generation rate may correspond to the rate at which the draft model 402 generates tokens, with tree pruning being based on target selection. Inference accuracy and speed may have an inverse relationship in this example, as a smaller draft model may generate tokens at a higher rate, but with a lower likelihood that the target model 404 will accept the tokens speculatively generated by the draft model 402; meanwhile, a larger draft model may generate tokens at a lower rate, but with a higher likelihood that the target model 404 will accept the tokens speculatively generated by the draft model 402.

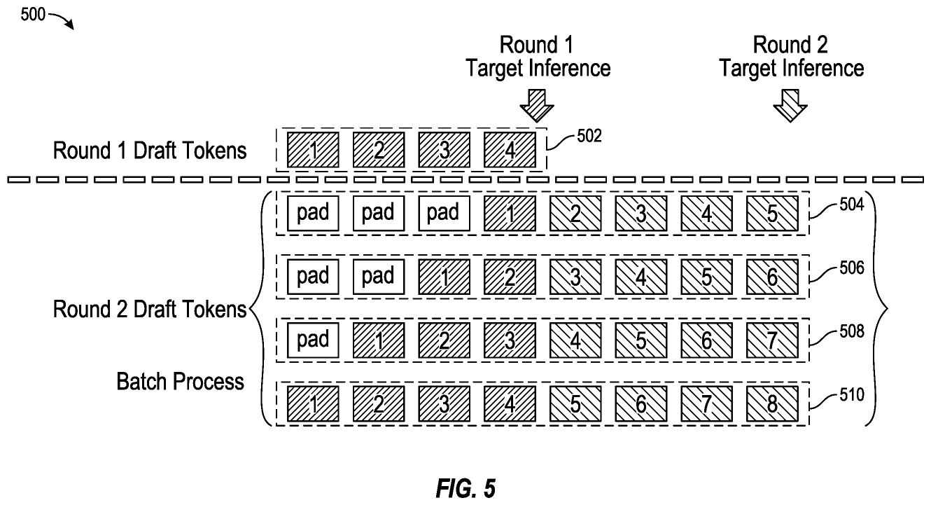

FIG. 5 illustrates an example 500 of hybrid speculative decoding in generative models, according to aspects of the present disclosure. In hybrid speculative decoding, a first set of speculatively generated tokens 502 (also referred to as “round 1 draft tokens”) generated by the draft model (e.g., the draft model 402 illustrated in FIG. 4) in a first round of inferencing may be provided to the target model (e.g., the target model 404 illustrated in FIG. 4) for verification. As discussed, in various aspects, the draft model may be executed on a first device, while the target model may be executed in a second device.

According to various aspects, while the first set of speculatively generated tokens 502 are processed by the target model, the draft model generates a second set of draft tokens in a second round of inferencing (also referred to as “round 2 draft tokens”), with assumptions being made for different numbers of accepted tokens. For example, as illustrated, the second set of draft tokens may include (1) a first subset 504 that assumes acceptance of the first draft token from the first set and may include a speculatively generated set of tokens based on acceptance of the first token; (2) a second subset 506 that assumes acceptance of the first and second draft tokens from the first set and includes a speculatively generated set of tokens based on acceptance of the first and second tokens; (3) a third subset 508 that assumes acceptance of the first through third draft tokens from the first set and includes a speculatively generated set of tokens based on acceptance of the first through third tokens; and (4) a fourth subset 510 that assumes acceptance of all four tokens from the first set and includes a speculatively generated set of tokens based on acceptance of all four tokens. For the cases in which fewer tokens than the number of tokens included in the first set are assumed to be accepted, padding (e.g., null values, predefined constants, etc.) can be added so that each assumption is of the same length. As illustrated, the second set of draft tokens may be generated in a batch process so that the appropriate selection of draft tokens, conditioned on a specific set of accepted tokens from the first set of speculatively generated tokens 502, can be provided to the target model for verification.

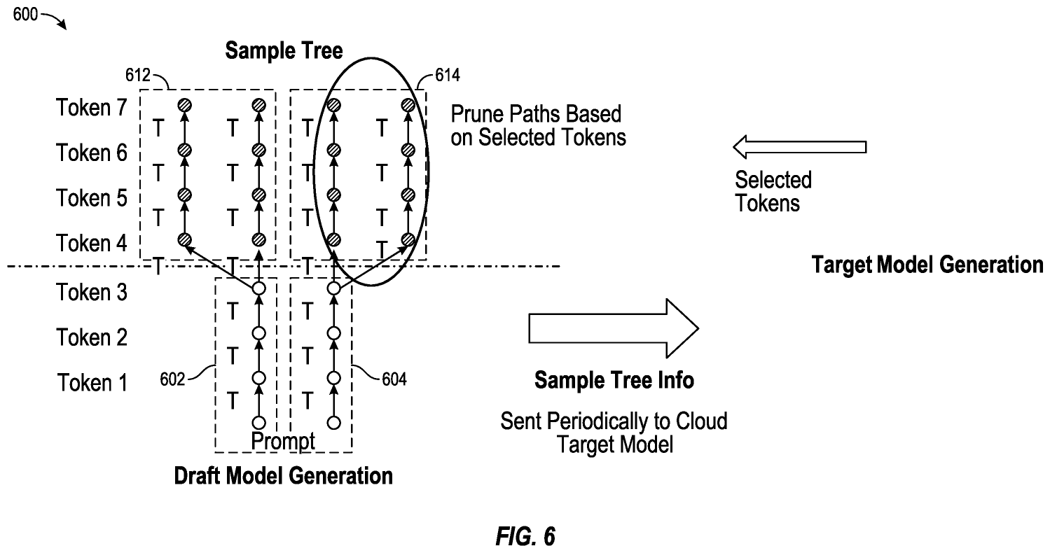

FIG. 6 illustrates an example 600 of hybrid speculative decoding in generative models, according to aspects of the present disclosure. In this example 600 (also referred to as an example of hybrid parallel speculative decoding (HPSD)), the parallel speculative decoding aspects discussed above may be used to generate various candidate sets of tokens for the target model to verify. The target model may operate continuously, as in speculative decoding performed on a per-token basis. However, instead of generating tokens on a per-token basis, the draft model can speculatively generate groups of tokens based on a probability distribution that approximates, but need not equal, the probability distribution associated with the target model and generate different tree data structures, as illustrated in FIG. 6, based on the input query (or prompt) and the generated groups of tokens. Based on some defined triggering criteria, an edge device (also referred to as a local device or first device) may provide the generated tree data structures to the target model operating on a server (e.g., in a cloud computing environment) (also referred to as a remote device or second device), which, as discussed above, selects a sequence of tokens corresponding to a likely valid response to an input query, and returns the selected sequence to the draft model executing on the edge device. Generally, the selected sequence of tokens may include the speculatively generated tokens that the target model can verify, plus one additional token generated based on the speculatively generated tokens. The draft model can then prune the generated tree to conform to the tokens verified by the target model.

As illustrated, different instances of a draft model, using different parameters, can independently generate a first speculative set of tokens 602 and a second speculative set of tokens 604 based on an input prompt. The draft model (e.g., executed on a local or first device) can provide the first speculative set of tokens 602 and the second speculative set of tokens 604 to a target model (e.g., executed on a remote or second device) for verification. In parallel, or at least substantially in parallel, with the target model verifying the first speculative set of tokens 602 and the second speculative set of tokens 604, the draft model can generate a first subsequent set of tokens 612 based on an assumption that the target model has accepted the first speculative set of tokens 602 and a second subsequent set of tokens 614 based on an assumption that the target model has accepted the second speculative set of tokens 604. In this example, as indicated by the oval, the target model has accepted the second speculative set of tokens 604 over the first speculative set of tokens 602 (e.g., in a similar fashion as described above with respect to FIG. 3). Because the target model has accepted the second speculative set of tokens 604, the draft model can discard the first subsequent set of tokens 612 and provide the second subsequent set of tokens 614 for verification by the target model. Further, though not shown, additional sets of tokens may be generated by the draft model based on the second subsequent set of tokens 614 while the target model verifies the second subsequent set of tokens 614.

The process of speculative token generation, pruning (e.g., by discarding non-selected sets of tokens), and target model verification may repeat until a terminating condition is reached for an input (e.g., that no further tokens need be generated in order to generate a proper response to the input query, a maximum number of tokens have been generated, a maximum amount of computing resources have been used to generate a response, etc.).

In this example, the overall token generation rate may correspond to the rate at which the draft model generates tokens. Previously generated tokens, however, may be discarded when the target model determines that no speculatively generated tokens in the generated tree are candidates for inclusion in response to the query, as the draft model may restart speculative token generation using tokens up to the last verified token as an input into the draft model. As with per-token-based hybrid speculative decoding, inference accuracy and speed may have an inverse relationship in this example, as a smaller draft model may generate tokens at a higher rate, but with a lower likelihood that the target model will accept the tokens speculatively generated by the draft model.

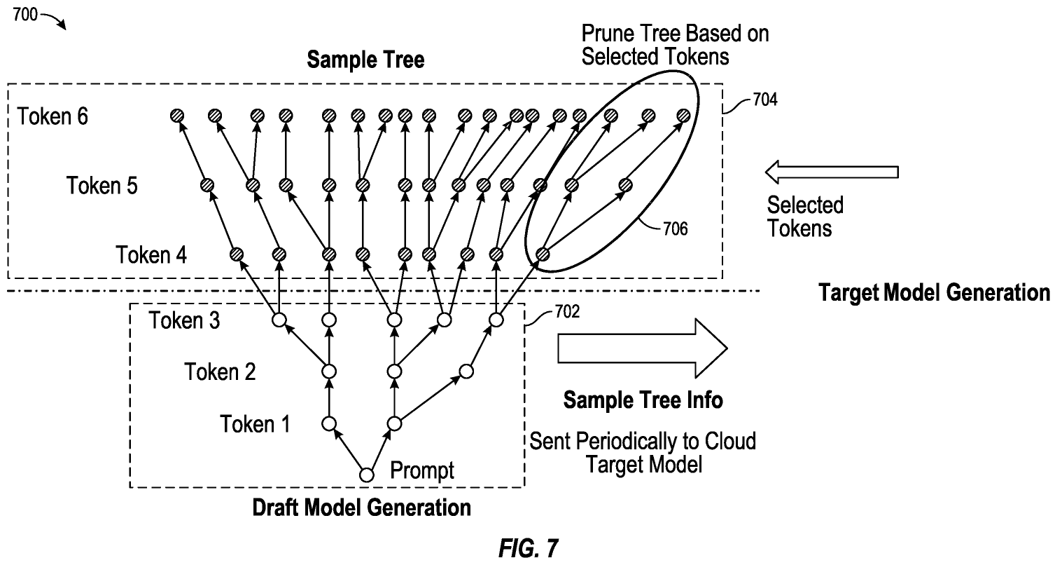

FIG. 7 illustrates an example 700 of hybrid group speculative decoding (HGSD) in generative models, according to aspects of the present disclosure. In this example 700, the group speculative decoding aspects discussed above may be used to generate various candidate sets of tokens for the target model to verify. The target model (e.g., executed on a remote or second device) may operate continuously, as in speculative decoding performed on a per-token basis. However, instead of generating tokens on a per-token basis, the draft model (e.g., executed on a local or first device) can generate groups of tokens speculatively based on a probability distribution that is equivalent to the probability distribution associated with the target model and generate a tree (e.g., a tree data structure) based on the input query (or prompt) and the generated groups of tokens. For example, based on some defined triggering criteria, an edge device may provide the generated tree to the target model operating on a server (e.g., in a cloud computing environment), which, as discussed above, may select a sequence of tokens corresponding to a likely valid response to the input query and return the selected sequence to the draft model executing on the edge device. Generally, the selected sequence of tokens may include the speculatively generated tokens that the target model can verify, plus one additional token generated based on the speculatively generated tokens. The draft model can then prune the generated tree to conform to the tokens verified by the target model.

For example, as illustrated, a tree data structure may be generated with the input prompt serving as a root node of the tree data structure. A first set of tokens 702, including a plurality of groups (represented as different paths through the tree), may be generated speculatively by the draft model and provided to the target model for verification, as discussed above. While the first set of tokens 702 is being verified by the target model, the draft model can speculatively generate a second set of tokens 704, with different subsets of tokens in the second set of tokens 704 being generated based on assumptions of different sets of tokens from the first set of tokens 702 being accepted by the target model. In the example 700, the selected set of tokens 706 may correspond to a set of tokens verified by the target model while the draft model generates subsequent sets of tokens. Generally, the tree data structure may be pruned, as discussed above, based on the verification by the target model of various groups of speculatively generated tokens, such that computing resources are not wasted on speculatively generating further groups of tokens based on prior sets of tokens that were not accepted by the target model.

Similar to the example 600 illustrated in FIG. 6, the overall token generation rate in hybrid group speculative decoding illustrated by the example 700 in FIG. 7 may correspond to the rate at which the draft model generates tokens. Previously generated tokens, however, may be discarded when the target model determines that no speculatively generated tokens in the generated tree are candidates for inclusion in response to the query, as the draft model may restart speculative token generation using tokens up to the last verified token as an input into the draft model. As with per-token-based hybrid speculative decoding, inference accuracy and speed may have an inverse relationship in this example, as a smaller draft model may generate tokens at a higher rate, but with a lower likelihood that the target model will accept the tokens speculatively generated by the draft model.

### Example Operations for Speculative Decoding in Generative Artificial Intelligence Models

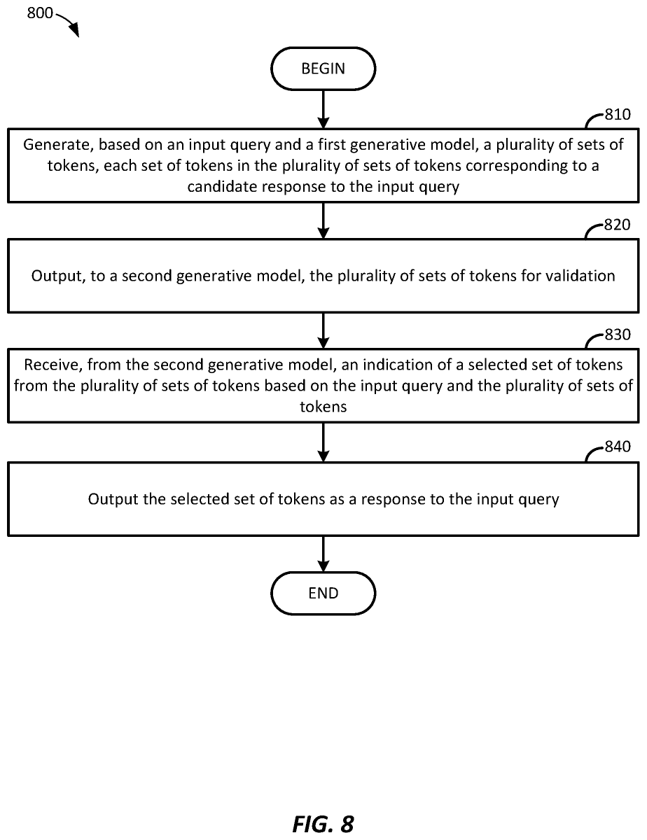

FIG. 8 illustrates example operations 800 that may be performed by a computing device to generate a response to an input query using generative artificial intelligence models, according to aspects of the present disclosure. The computing device for performing the operations 800 may be a device on which at least a draft model can be deployed, such as a smartphone, a tablet computer, a laptop computer, a desktop, a server, a cloud compute instance hosted in a distributed computing environment, or the like.

As illustrated, the operations 800 begin at block 810, with the computing device generating, based on an input query and a first generative model, a plurality of sets of tokens. Generally, each set of tokens in the plurality of sets of tokens may correspond to a candidate answer to the input query. The input query may be received, for example, from a user of the computing device at a prompt into which a textual query can be input, through conversion of a natural language utterance into a textual representation of the input query, etc.

At block 820, the operations 800 proceed with the computing device outputting, to a second generative model, the plurality of sets of tokens for verification (e.g., by another computing device).

At block 830, the operations 800 proceed with the computing device receiving, from the second generative model, an indication of a selected set of tokens from the plurality of sets of tokens based on the input query and the plurality of sets of tokens.

At block 840, the operations 800 proceed with the computing device outputting (e.g., to a user or application, to another model, etc.) the selected set of tokens as a response to the input query.

In some aspects, each set of tokens in the plurality of sets of tokens comprises a group of tokens having the highest probabilities within a probability distribution associated with the first generative model over a universe of tokens based on which the first generative model is trained.

In some aspects, each set of tokens in the plurality of sets of tokens comprises a group of tokens selected based on a sum of probabilities associated with tokens in the group of tokens, the sum exceeding a threshold probability.

In some aspects, the plurality of sets of tokens are represented as a tree data structure. Within the tree data structure, a root node may generally correspond to the input query, and different paths through the tree data structure may generally correspond to different sets of tokens from the plurality of sets of tokens. The depth of the tree data structure may, in some aspects, correspond to a maximum number of tokens generated by a single pass through the first generative model, and a maximum size of the tree data structure may be set based on a computational complexity metric associated with generating a target set of tokens by the second generative model.

In some aspects, the operations 800 may further include pruning a tree data structure based on the selected set of tokens. A subsequent plurality of sets of tokens are generated based on the pruned tree data structure and the input query and output to the second generative model for verification. An indication of a subsequent selected set of tokens from the subsequent plurality of sets of tokens is received from the second generative model based on the input query, the pruned tree data structure, and the subsequent plurality of sets of tokens. Outputting the selected set of tokens as the response to the input query may include outputting the selected set of tokens and the subsequent selected set of tokens as the response to the input query.

In some aspects, each respective set of tokens in the plurality of sets of tokens may be generated using a unique instance of the first generative model and unique parameters as inputs into the unique instance of the first generative model.

In some aspects, the operations 800 may further include generating a subsequent plurality of sets of tokens based on the input query and the plurality of sets of tokens while the second generative model verifies the plurality of sets of tokens. Based on the subsequent plurality of sets of tokens and the selected set of tokens, a refined subsequent set of tokens may be generated, and the refined subsequent set of tokens may be output to the second generative model for verification.

In some aspects, sets of tokens in the subsequent plurality of sets of tokens may include padding accounting for a number of tokens in the selected set of tokens being less than a maximum number of tokens (or a preconfigured number of tokens).

In some aspects, the operations 800 further include receiving a token generated by the second generative model based on the selected set of tokens. The received token may be output as an additional token subsequent to the selected set of tokens.

In some aspects, the first generative model may correspond to a draft model in a speculative decoding pipeline, and the second generative model may correspond to a target model in the speculative decoding pipeline.

In some aspects, the first generative model and the second generative model may have equivalent probability distributions.

In some aspects, the first generative model may have a probability distribution that approximates a probability distribution associated with the second generative model. An approximation of a probability distribution may be a probability distribution that falls within a threshold difference from the probability distribution associated with the second generative model, such that the probability distribution associated with the first generative model need not be an exact match to the probability distribution associated with the second generative model.

In some aspects, the first generative model may execute locally (e.g., on a local device or a local system), and the second generative model may be a model hosted remotely (e.g., on a remote system or a remote device).

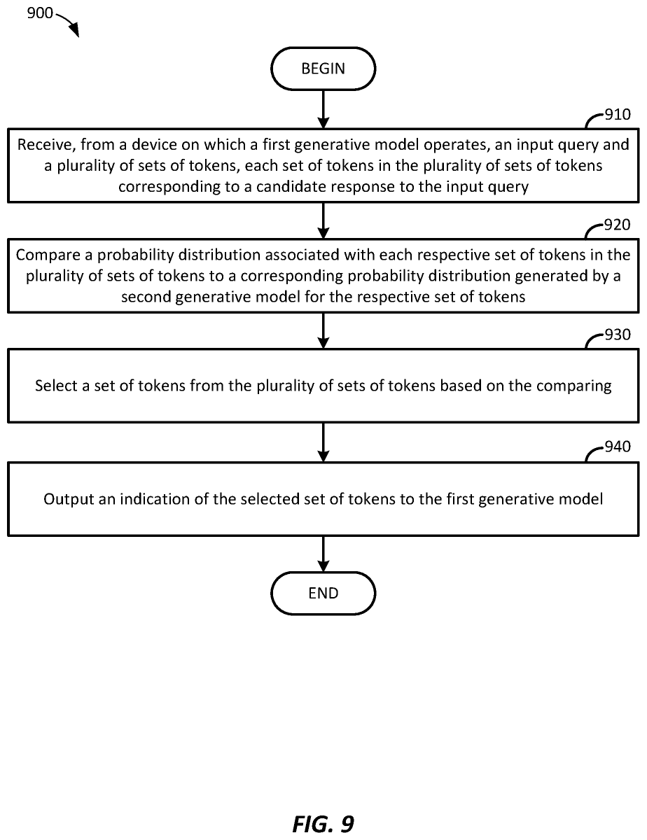

FIG. 9 illustrates example operations 900 for verifying a response to an input query using generative artificial intelligence models, according to aspects of the present disclosure. The operations 900 may be performed by a device (or a system with multiple devices) on which at least a target model can be deployed, such as a server (e.g., the server 405 of FIG. 4), a cloud compute instance hosted in a distributed computing environment, or the like.

As illustrated, the operations 900 begin at block 910, with receiving, from a device on which a first generative model operates, an input query and a plurality of sets of tokens, each set of tokens in the plurality of sets of tokens corresponding to a candidate response to the input query.

At block 920, the operations 900 proceed with comparing a probability distribution associated with each respective set of tokens in the plurality of sets of tokens to a corresponding probability distribution generated by a second generative model for the respective set of tokens.

At block 930, the operations 900 proceed with selecting a set of tokens from the plurality of sets of tokens based on the comparing.

At block 940, the operations 900 proceed with outputting an indication of the selected set of tokens to the first generative model.

In some aspects, the plurality of sets of tokens are represented as a tree data structure. Within the tree data structure, a root node may generally correspond to the input query, and different paths through the tree data structure may generally correspond to different sets of tokens from the plurality of sets of tokens. The depth of the tree data structure may, in some aspects, correspond to a maximum number of tokens generated by a single pass through the first generative model, and a maximum size of the tree data structure may be set based on a computational complexity metric associated with generating a target set of tokens by the second generative model.

In some aspects, comparing the probability distribution associated with each respective set of tokens in the plurality of sets of tokens to a corresponding probability distribution generated by a second generative model for the respective set of tokens comprises generating probability distributions for each respective set of tokens based on a single pass through the second generative model. The single pass through the second generative model may be performed based on masked self-attention and positional encodings in a tree data structure.

In some aspects, the operations 900 further include generating an additional token based on the selected set of tokens using the second generative model. The additional token (or an indication thereof) may be output to the first generative model, in conjunction with the selected set of tokens (or as part of the indication of the selected set of tokens).

In some aspects, the first generative model may correspond to a draft model in a speculative decoding pipeline, and the second generative model may correspond to a target model in the speculative decoding pipeline.

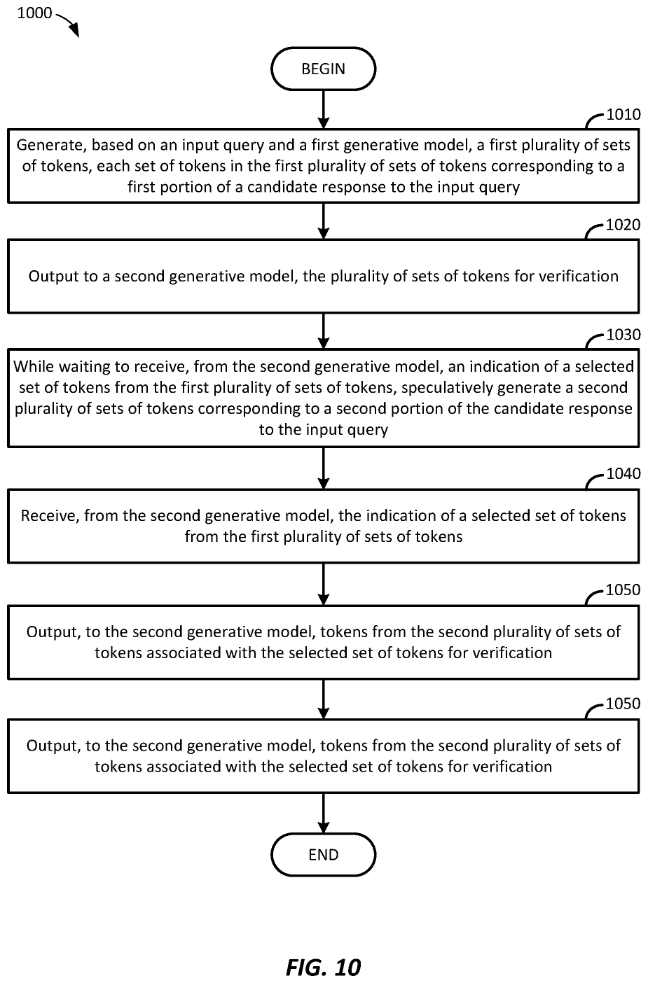

FIG. 10 illustrates example operations 1000 that may be performed by a computing device for speculatively generating a response to an input query and verifying the response to the input query using generative artificial intelligence models, according to aspects of the present disclosure. The computing device for performing the operations 800 may be a device on which at least a draft model can be deployed, such as a smartphone, a tablet computer, a laptop computer, a desktop, a server, a cloud compute instance hosted in a distributed computing environment, or the like.

As illustrated, the operations 1000 begin at block 1010, with the computing device generating, based on an input query and a first generative model, a first plurality of sets of tokens. Generally, each set of tokens in the first plurality of sets of tokens may correspond to a candidate answer to the input query. The input query may be received, for example, from a user of the computing device at a prompt into which a textual query can be input, through conversion of a natural language utterance into a textual representation of the input query, etc.

At block 1020, the operations 1000 proceed with the computing device outputting, to a second generative model, the first plurality of sets of tokens for verification (e.g., by another computing device).

At block 1030, the operations 1000 proceed with the computing device speculatively generating, while waiting to receive an indication of a selected set of tokens from the first plurality of sets of tokens from the second generative model, a second plurality of sets of tokens. Each set of tokens in the second plurality of sets of tokens generally correspond to a second portion of the candidate response to the input query.

At block 1040, the operations 1000 proceed with receiving, from the second generative model, the indication of the selected set of tokens from the plurality of sets of tokens.

At block 1050, the operations 1000 proceed with outputting, to the second generative model, tokens from the second plurality of sets of tokens associated with the selected set of tokens for verification.

At block 1060, the operations 1000 proceed with outputting (e.g., to a user or application, to another model, etc.) the selected set of tokens as a response to the input query.

In some aspects, the operations 1000 further include receiving an indication of a second selected set of tokens from the second plurality of sets of tokens associated with the selected set of tokens. The second selected set of tokens may be output (e.g., to a user or application, to another model, etc.) as another portion of the response to the input query.

In some aspects, each set of tokens in the first plurality of sets of tokens comprises a group of tokens having the highest probabilities within a probability distribution associated with the first generative model over a universe of tokens.

In some aspects, each set of tokens in the first plurality of sets of tokens comprises a group of tokens selected based on a sum of probabilities associated with tokens in the group of tokens, the sum exceeding a threshold probability.

In some aspects, the first plurality of sets of tokens may be represented as a tree data structure. Within the tree data structure, a root node may correspond to the input query. Each path through the tree data structure may correspond to a set of tokens from the first plurality of sets of tokens.

In some aspects, each respective set of tokens in the first plurality of sets of tokens is generated using a unique instance of the first generative model and unique parameters as inputs into the unique instance of the first generative model.

In some aspects, the operations 1000 further include generate a refined subsequent set of tokens based on the selected set of tokens and the second plurality of sets of tokens. The refined subsequent set of tokens for verification may be output to the second generative model. While waiting to receive an indication of a second selected set of tokens from the refined subsequent set of tokens, a third plurality of sets of tokens may be speculatively generated. In some aspects, sets of tokens in the subsequent plurality of sets of tokens include padding accounting for a number of tokens in the selected set of tokens being less than a maximum number of tokens.

In some aspects, the first generative model may correspond to a draft model in a speculative decoding pipeline. The second generative model may correspond to a target model in the speculative decoding pipeline.

In some aspects, the first generative model may have a probability distribution that approximates a probability distribution associated with the second generative model. An approximation of a probability distribution may be a probability distribution that falls within a threshold difference from the probability distribution associated with the second generative model, such that the probability distribution associated with the first generative model need not be an exact match to the probability distribution associated with the second generative model.

In some aspects, the first generative model may execute locally (e.g., on a local device or a local system), and the second generative model may be a model hosted remotely (e.g., on a remote system or a remote device).

Example Processing Systems for Speculative Decoding in Generative Artificial Intelligence Models

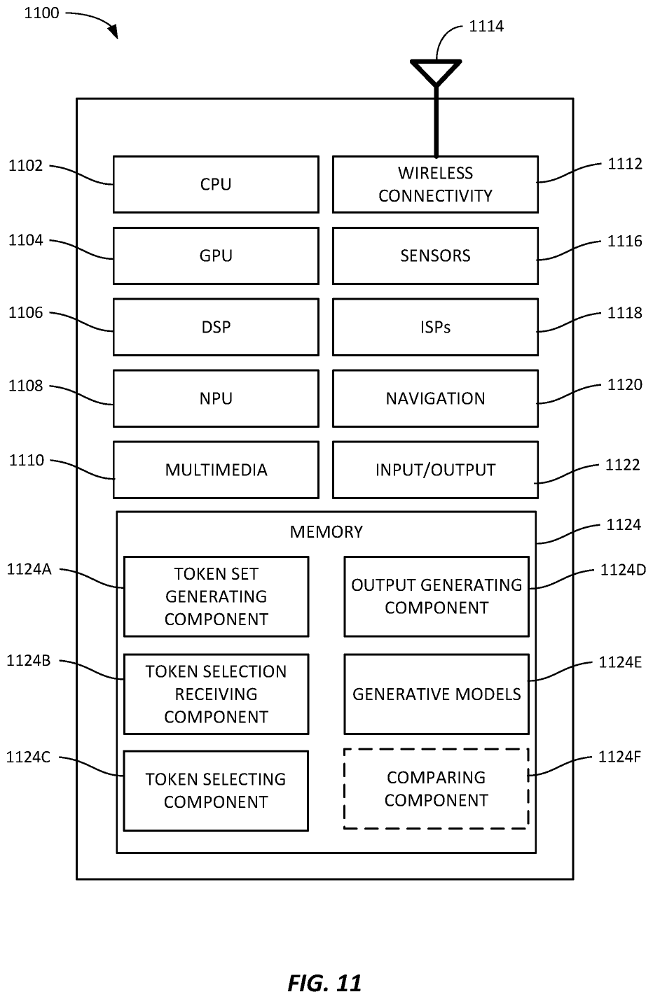

FIG. 11 depicts an example processing system 1100 for generating a response to a query input into a generative artificial intelligence model based on group speculative decoding, such as described herein for example with respect to FIGS. 8 through 10.

The processing system 1100 includes a central processing unit (CPU) 1102, which in some examples may be a multi-core CPU. Instructions executed at the CPU 1102 may be loaded, for example, from a program memory associated with the CPU 1102 or may be loaded from a memory partition (e.g., of memory 1124).

The processing system 1100 also includes additional processing components tailored to specific functions, such as a graphics processing unit (GPU) 1104, a digital signal processor (DSP) 1106, a neural processing unit (NPU) 1108, and a connectivity component 1112.

An NPU, such as the NPU 1108, is generally a specialized circuit configured for implementing control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as the NPU 1108, are configured to accelerate the performance of common machine learning tasks, such as image classification, machine translation, object detection, and various other predictive models. In some examples, a plurality of NPUs may be instantiated on a single chip, such as a system on a chip (SoC), while in other examples such NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this new piece through an already trained model to generate a model output (e.g., an inference).

In some implementations, the NPU 1108 is a part of one or more of the CPU 1102, the GPU 1104, and/or the DSP 1106. These may be located on a user equipment (UE) in a wireless communication system or another computing device.

In some examples, a connectivity component 1112 may include subcomponents, for example, for third generation (3G) connectivity, fourth generation (4G) connectivity (e.g., Long-Term Evolution (LTE)), fifth generation (5G) connectivity (e.g., New Radio (NR)), Wi-Fi connectivity, Bluetooth connectivity, and other wireless data transmission standards. The connectivity component 1112 may be further coupled to one or more antennas 1114.

The processing system 1100 may also include one or more sensor processing units 1116 associated with any manner of sensor, one or more image signal processors (ISPs) 1118 associated with any manner of image sensor, and/or a navigation processor 1120, which may include satellite-based positioning system components (e.g., GPS or GLONASS) as well as inertial positioning system components.

The processing system 1100 may also include one or more input and/or output devices 1122, such as screens, touch-sensitive surfaces (including touch-sensitive displays), physical buttons, speakers, microphones, and the like.

In some examples, one or more of the processors of the processing system 1100 may be based on an ARM or RISC-V instruction set.

The processing system 1100 also includes a memory 1124, which is representative of one or more static and/or dynamic memories, such as a dynamic random access memory, a flash-based static memory, and the like. In this example, the memory 1124 includes computer-executable components, which may be executed by one or more of the aforementioned processors of the processing system 1100.

In particular, in this example, the memory 1124 includes a token set generating component 1124A, a token selection receiving component 1124B, a token selecting component 1026C, and output generating component 1124D, generative models 1124E, and optionally a comparing component 1124F. The depicted components, and others not depicted, may be configured to perform various aspects of the methods described herein.

Generally, the processing system 1100 and/or components thereof may be configured to perform the methods described herein.

### EXAMPLE CLAUSES

Implementation details of various aspects of the present disclosure are described in the following numbered clauses:

Clause 1: A processor-implemented method, comprising: generating, based on an input query and a first generative model, a plurality of sets of tokens, each set of tokens in the plurality of sets of tokens corresponding to a candidate response to the input query; outputting, to a second generative model, the plurality of sets of tokens for verification; receiving, from the second generative model, an indication of a selected set of tokens from the plurality of sets of tokens based on the input query and the plurality of sets of tokens; and outputting the selected set of tokens as a response to the input query.

Clause 2: The method of Clause 1, wherein each set of tokens in the plurality of sets of tokens comprises a group of tokens having the highest probabilities within a probability distribution associated with the first generative model over a universe of tokens.

Clause 3: The method of Clause 1 or 2, wherein each set of tokens in the plurality of sets of tokens comprises a group of tokens selected based on a sum of probabilities associated with tokens in the group of tokens, the sum exceeding a threshold probability.

Clause 4: The method of any of Clauses 1 through 3, wherein: the plurality of sets of tokens are represented as a tree data structure, a root node of the tree data structure corresponds to the input query, and each path through the tree data structure corresponds to a set of tokens from the plurality of sets of tokens.

Clause 5: The method of Clause 4, wherein a depth of the tree data structure corresponds to a maximum number of tokens generated by a single pass through the first generative model.

Clause 6: The method of Clause 4 or 5, wherein a maximum size of the tree data structure is set based on a computational complexity metric associated with generating a target set of tokens by the second generative model.

Clause 7: The method of any of Clauses 4 through 6, further comprising: pruning the tree data structure based on the selected set of tokens; generating a subsequent plurality of sets of tokens based on the pruned tree data structure and the input query; outputting, to the second generative model, the subsequent plurality of sets of tokens for verification; and receiving, from the second generative model, an indication of a subsequent selected set of tokens from the subsequent plurality of sets of tokens based on the input query, the pruned tree data structure, and the subsequent plurality of sets of tokens, wherein outputting the selected set of tokens as the response to the input query comprises outputting the selected set of tokens and the subsequent selected set of tokens as the response to the input query.

Clause 8: The method of any of Clauses 1 through 7, wherein each respective set of tokens in the plurality of sets of tokens is generated using a unique instance of the first generative model and unique parameters as inputs into the unique instance of the first generative model.

Clause 9: The method of any of Clauses 1 through 8, further comprising: while the second generative model verifies the plurality of sets of tokens, generating a subsequent plurality of sets of tokens based on the input query and the plurality of sets of tokens; based on the subsequent plurality of sets of tokens and the selected set of tokens, generating a refined subsequent set of tokens; and outputting, to the second generative model, the refined subsequent set of tokens for verification.

Clause 10: The method of Clause 9, wherein sets of tokens in the subsequent plurality of sets of tokens include padding accounting for a number of tokens in the selected set of tokens being less than a maximum number of tokens.

Clause 11: The method of any of Clauses 1 through 10, further comprising: receiving a token generated by the second generative model based on the selected set of tokens; and outputting the received token as an additional token subsequent to the selected set of tokens.

Clause 12: The method of any of Clauses 1 through 11, wherein: the first generative model corresponds to a draft model in a speculative decoding pipeline, and the second generative model corresponds to a target model in the speculative decoding pipeline.

Clause 13: The method of Clause 12, wherein the draft model comprises a model trained to have a probability distribution that approximates a corresponding probability distribution for the target model.

Clause 14: The method of any of Clauses 1 through 13, wherein: the first generative model comprises a model executing on a local system, and the second generative model comprises a model executing on a remote system.

Clause 15: A processor-implemented method, comprising: receiving an input query and a plurality of sets of tokens generated by a first generative model, each respective set of tokens in the plurality of sets of tokens corresponding to a respective candidate response to the input query; comparing a probability distribution associated with each respective set of tokens in the plurality of sets of tokens to a corresponding probability distribution generated by a second generative model for the respective set of tokens; selecting a set of tokens from the plurality of sets of tokens based on the comparing; and outputting, to the first generative model, an indication of the selected set of tokens.

Clause 16: The method of Clause 15, wherein: the plurality of sets of tokens are represented as a tree data structure, a root node of the tree data structure corresponds to the input query, and each path through the tree data structure corresponds to a set of tokens from the plurality of sets of tokens.

Clause 17: The method of Clause 15 or 16, wherein comparing the probability distribution associated with each respective set of tokens in the plurality of sets of tokens to the corresponding probability distribution generated by the second generative model for the respective set of tokens comprises generating probability distributions for each respective set of tokens based on a single pass through the second generative model.

Clause 18: The method of Clause 17, wherein the single pass through the second generative model is performed based on masked self-attention and positional encodings in a tree data structure.

Clause 19: The method of any of Clauses 15 through 18, further comprising: generating an additional token based on the selected set of tokens using the second generative model; and outputting the additional token to the first generative model.

Clause 20: The method of any of Clauses 15 through 19, wherein: the first generative model corresponds to a draft model in a speculative decoding pipeline, and the second generative model corresponds to a target model in the speculative decoding pipeline.

Clause 21: A processor-implemented method, comprising: generating, based on an input query and a first generative model, a first plurality of sets of tokens, each set of tokens in the first plurality of sets of tokens corresponding to a first portion of a candidate response to the input query; outputting to a second generative model, the plurality of sets of tokens for verification; while waiting to receive, from the second generative model, an indication of a selected set of tokens from the first plurality of sets of tokens, speculatively generating a second plurality of sets of tokens, each set of tokens in the second plurality of sets of tokens corresponding to a second portion of the candidate response to the input query; receiving, from the second generative model, the indication of the selected set of tokens from the first plurality of sets of tokens; outputting, to the second generative model, tokens from the second plurality of sets of tokens associated with the selected set of tokens for verification; and outputting the selected set of tokens as a response to the input query.

Clause 22: The method of claim 21, further comprising: receiving an indication of a second selected set of tokens from the second plurality of sets of tokens associated with the selected set of tokens; and outputting the second selected set of tokens as another portion of the response to the input query.

Clause 23: The method of Clause 21 or 22, wherein each set of tokens in the first plurality of sets of tokens comprises a group of tokens having the highest probabilities within a probability distribution associated with the first generative model over a universe of tokens.

Clause 24: The method of any of Clauses 21 through 23, wherein each set of tokens in the first plurality of sets of tokens comprises a group of tokens selected based on a sum of probabilities associated with tokens in the group of tokens, the sum exceeding a threshold probability.

Clause 25: The method of any of Clauses 21 through 24, wherein: the first plurality of sets of tokens are represented as a tree data structure, a root node of the tree data structure corresponds to the input query, and each path through the tree data structure corresponds to a set of tokens from the first plurality of sets of tokens.

Clause 26: The method of any of Clauses 21 through 25, wherein each respective set of tokens in the first plurality of sets of tokens is generated using a unique instance of the first generative model and unique parameters as inputs into the unique instance of the first generative model.

Clause 27: The method of any of Clauses 21 through 26, further comprising: generating a refined subsequent set of tokens based on the selected set of tokens and the second plurality of sets of tokens; outputting, to the second generative model, the refined subsequent set of tokens for verification; and while waiting to receive, from the second generative model, an indication of a second selected set of tokens from the refined subsequent set of tokens; speculatively generating a third plurality of sets of tokens.

Clause 28: The method of Clause 27, wherein sets of tokens in the subsequent plurality of sets of tokens include padding accounting for a number of tokens in the selected set of tokens being less than a maximum number of tokens.

Clause 29: The method of any of Clauses 21 through 28, wherein: the first generative model corresponds to a draft model in a speculative decoding pipeline, and the second generative model corresponds to a target model in the speculative decoding pipeline.

Clause 30: The method of Clause 29, wherein the draft model comprises a model trained to have a probability distribution that approximates a corresponding probability distribution for the target model.

Clause 31: The method of any of Clauses 21 through 30, wherein: the first generative model comprises a model executing on a local system, and the second generative model comprises a model executing on a remote system.

Clause 32: A processing system comprising: a memory having executable instructions stored thereon; and one or more processors configured to execute the executable instructions to cause the processing system to perform the method of any of Clauses 1 through 31.

Clause 33: A processing system, comprising: means for performing the method of any of Clauses 1 through 31.

Clause 34: A computer-readable medium having instructions stored thereon which, when executed by one or more processors, cause the one or more processors to perform the method of any of Clauses 1 through 31.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processing system, comprising:
a memory having executable instructions stored thereon; and
one or more processors configured to execute the executable instructions to cause the processing system to:
generate, based on an input query and a first generative model, a first plurality of sets of tokens, each set of tokens in the first plurality of sets of tokens corresponding to a first portion of a candidate response to the input query;
output to a second generative model, the plurality of sets of tokens for verification;
while waiting to receive, from the second generative model, an indication of a selected set of tokens from the first plurality of sets of tokens, speculatively generate a second plurality of sets of tokens, each set of tokens in the second plurality of sets of tokens corresponding to a second portion of the candidate response to the input query;
receive, from the second generative model, the indication of the selected set of tokens from the first plurality of sets of tokens;
output, to the second generative model, tokens from the second plurality of sets of tokens associated with the selected set of tokens for verification; and
output the selected set of tokens as a response to the input query.

2. The processing system of claim 1, wherein the one or more processors are further configured to cause the processing system to:
receive an indication of a second selected set of tokens from the second plurality of sets of tokens associated with the selected set of tokens; and
output the second selected set of tokens as another portion of the response to the input query.

3. The processing system of claim 1, wherein each set of tokens in the first plurality of sets of tokens comprises a group of tokens having the highest probabilities within a probability distribution associated with the first generative model over a universe of tokens.

4. The processing system of claim 1, wherein each set of tokens in the first plurality of sets of tokens comprises a group of tokens selected based on a sum of probabilities associated with tokens in the group of tokens, the sum exceeding a threshold probability.

5. The processing system of claim 1, wherein:
the first plurality of sets of tokens are represented as a tree data structure,
a root node of the tree data structure corresponds to the input query, and
each path through the tree data structure corresponds to a set of tokens from the first plurality of sets of tokens.

6. The processing system of claim 1, wherein each respective set of tokens in the first plurality of sets of tokens is generated using a unique instance of the first generative model and unique parameters as inputs into the unique instance of the first generative model.

7. The processing system of claim 1, wherein the one or more processors are further configured to cause the processing system to:
generate a refined subsequent set of tokens based on the selected set of tokens and the second plurality of sets of tokens;
output, to the second generative model, the refined subsequent set of tokens for verification; and
while waiting to receive, from the second generative model, an indication of a second selected set of tokens from the refined subsequent set of tokens, speculatively generate a third plurality of sets of tokens.

8. The processing system of claim 7, wherein sets of tokens in the subsequent plurality of sets of tokens include padding accounting for a number of tokens in the selected set of tokens being less than a maximum number of tokens.

9. The processing system of claim 1, wherein:
the first generative model corresponds to a draft model in a speculative decoding pipeline, and
the second generative model corresponds to a target model in the speculative decoding pipeline.

10. The processing system of claim 9, wherein the draft model comprises a model trained to have a probability distribution that approximates a corresponding probability distribution for the target model.

11. The processing system of claim 1, wherein:
the first generative model comprises a model executing on a local system, and
the second generative model comprises a model executing on a remote system.

12. A processor-implemented method, comprising:
generating, based on an input query and a first generative model, a first plurality of sets of tokens, each set of tokens in the first plurality of sets of tokens corresponding to a first portion of a candidate response to the input query;
outputting to a second generative model, the plurality of sets of tokens for verification;
while waiting to receive, from the second generative model, an indication of a selected set of tokens from the first plurality of sets of tokens, speculatively generating a second plurality of sets of tokens, each set of tokens in the second plurality of sets of tokens corresponding to a second portion of the candidate response to the input query;
receiving, from the second generative model, the indication of the selected set of tokens from the first plurality of sets of tokens;
outputting, to the second generative model, tokens from the second plurality of sets of tokens associated with the selected set of tokens for verification; and
outputting the selected set of tokens as a response to the input query.

13. The method of claim 12, further comprising:
receiving an indication of a second selected set of tokens from the second plurality of sets of tokens associated with the selected set of tokens; and
outputting the second selected set of tokens as another portion of the response to the input query.

14. The method of claim 12, wherein each set of tokens in the first plurality of sets of tokens comprises a group of tokens having the highest probabilities within a probability distribution associated with the first generative model over a universe of tokens.

15. The method of claim 12, wherein each set of tokens in the first plurality of sets of tokens comprises a group of tokens selected based on a sum of probabilities associated with tokens in the group of tokens, the sum exceeding a threshold probability.

16. The method of claim 12, wherein:
the first plurality of sets of tokens are represented as a tree data structure,
a root node of the tree data structure corresponds to the input query, and
each path through the tree data structure corresponds to a set of tokens from the first plurality of sets of tokens.

17. The method of claim 12, wherein each respective set of tokens in the first plurality of sets of tokens is generated using a unique instance of the first generative model and unique parameters as inputs into the unique instance of the first generative model.

18. The method of claim 12, further comprising:
generating a refined subsequent set of tokens based on the selected set of tokens and the second plurality of sets of tokens;
outputting, to the second generative model, the refined subsequent set of tokens for verification; and
while waiting to receive, from the second generative model, an indication of a second selected set of tokens from the refined subsequent set of tokens, speculatively generating a third plurality of sets of tokens.

19. The method of claim 18, wherein sets of tokens in the subsequent plurality of sets of tokens include padding accounting for a number of tokens in the selected set of tokens being less than a maximum number of tokens.

20. The method of claim 12, wherein:
the first generative model corresponds to a draft model in a speculative decoding pipeline, and
the second generative model corresponds to a target model in the speculative decoding pipeline.

21. The method of claim 20, wherein the draft model comprises a model trained to have a probability distribution that approximates a corresponding probability distribution for the target model.

22. The method of claim 12, wherein:
the first generative model comprises a model executing on a local system, and
the second generative model comprises a model executing on a remote system.

23. A processing system, comprising:
means for generating, based on an input query and a first generative model, a first plurality of sets of tokens, each set of tokens in the first plurality of sets of tokens corresponding to a first portion of a candidate response to the input query;
means for outputting to a second generative model, the plurality of sets of tokens for verification;
means for speculatively generating, while waiting to receive, from the second generative model, an indication of a selected set of tokens from the first plurality of sets of tokens, a second plurality of sets of tokens, each set of tokens in the second plurality of sets of tokens corresponding to a second portion of the candidate response to the input query;
means for receiving, from the second generative model, the indication of the selected set of tokens from the first plurality of sets of tokens;
means for outputting, to the second generative model, tokens from the second plurality of sets of tokens associated with the selected set of tokens for verification; and
means for outputting the selected set of tokens as a response to the input query.

24. The processing system of claim 23, further comprising:
means for receiving an indication of a second selected set of tokens from the second plurality of sets of tokens associated with the selected set of tokens; and
means for outputting the second selected set of tokens as another portion of the response to the input query.

25. The processing system of claim 23, wherein:
the first plurality of sets of tokens are represented as a tree data structure,
a root node of the tree data structure corresponds to the input query, and
each path through the tree data structure corresponds to a set of tokens from the first plurality of sets of tokens.

26. The processing system of claim 23, wherein each respective set of tokens in the first plurality of sets of tokens is generated using a unique instance of the first generative model and unique parameters as inputs into the unique instance of the first generative model.

27. The processing system of claim 23, further comprising:
means for generating a refined subsequent set of tokens based on the selected set of tokens and the second plurality of sets of tokens;
means for outputting, to the second generative model, the refined subsequent set of tokens for verification; and
means for speculatively generating, while waiting to receive, from the second generative model, an indication of a second selected set of tokens from the refined subsequent set of tokens, a third plurality of sets of tokens.

28. The processing system of claim 23, wherein:
the first generative model corresponds to a draft model in a speculative decoding pipeline, and
the second generative model corresponds to a target model in the speculative decoding pipeline.

29. The processing system of claim 23, wherein:
the first generative model comprises a model executing on a local system, and
the second generative model comprises a model executing on a remote system.

30. A computer-readable medium having executable instructions stored thereon which, when executed by one or more processors, perform an operation comprising:
generating, based on an input query and a first generative model, a first plurality of sets of tokens, each set of tokens in the first plurality of sets of tokens corresponding to a first portion of a candidate response to the input query;
outputting to a second generative model, the plurality of sets of tokens for verification;
while waiting to receive, from the second generative model, an indication of a selected set of tokens from the first plurality of sets of tokens, speculatively generating a second plurality of sets of tokens, each set of tokens in the second plurality of sets of tokens corresponding to a second portion of the candidate response to the input query;
receiving, from the second generative model, the indication of the selected set of tokens from the first plurality of sets of tokens;
outputting, to the second generative model, tokens from the second plurality of sets of tokens associated with the selected set of tokens for verification; and
outputting the selected set of tokens as a response to the input query.
